(19) United States
(12) Patent Application Publication
(10) Pub. No.: US 2026/0053194 A1
(43) Pub. Date: Feb. 26, 2026

(54) INDUCTION HEATING MODULE FOR USE IN AN INDUCTIVELY HEATING AEROSOLGENERATING DEVICE

(71) Applicant: Philip Morris Products S.A., Neuchâtel (CH)

(72) Inventors: David Murray CROSS, Willian Letchworth (GB); Stuart Michael Ruan JONES, Meldreth Royston (GB); Patrick Charles SILVESTRINI, Neuchâtel (CH); Enrico STURA, Palézieux-Village (CH)

(73) Assignee: Philip Morris Products S.A., Neuchâtel (CH)

(21) Appl. No.: 19/099,652

(22) PCT Filed: Aug. 9, 2023
(86) PCT No.: PCT/EP2023/072030

§ 371 Date: Jan. 29, 2025

(30) Foreign Application Priority Data
Aug. 11, 2022 (EP) 22189823.2

(51) Int. Cl. A24F 40/465; A24F 40/10; A24F 40/42; H05B 6/10

(52) U.S. Cl. CPC A24F 40/465; A24F 40/10; A24F 40/42; H05B 6/108

(57) ABSTRACT

An induction heating module for an aerosol-generating device, including: a cylindrical-helical induction coil to generate an alternating magnetic field to inductively heat a susceptor within the coil to heat an aerosol-forming substrate in thermal contact or thermal proximity with the susceptor, the coil formed by turns of a coil wire having circular cross-section; and a coil support including a support tube, the coil being wound around a circumference of the tube including a wire recess pattern and two flux concentration recesses for receiving a respective annular protrusion portion of a flux concentrator, the pattern being axially arranged between two flux concentration recesses, the circumference having a non-circular flattened transverse cross-sectional shape including two opposing flat sections connected by two opposing partially curved sections, the coil wound around the circumference such that a transverse cross-sectional shape of the coil follows the non-circular flattened transverse cross-sectional shape of the circumference.

The present disclosure relates to an induction heating module for use in an inductively heating aerosol-generating device. The invention further relates to an aerosol-generating device and an aerosol-generating system comprising such an induction heating module.

Aerosol-generating devices and systems used for generating inhalable aerosols by inductively heating aerosol-forming substrates are generally known from prior art. Such systems and devices may comprise an induction heating arrangement including an induction coil for generating an alternating magnetic field. The field is used to induce at least one of heat generating eddy currents or hysteresis losses in a susceptor which is arranged in thermal proximity or direct physical contact with an aerosol-forming substrate that is capable to form inhalable aerosols upon heating. The susceptor and the substrate may be part of an aerosol-generating article that is receivable within the interior space of the induction coil. In particular, the substrate may be a liquid aerosol-forming substrate that is stored in a liquid reservoir of the article. The reservoir may be in fluid communication with a susceptor that is located in an evaporation portion of the article where the aerosol-forming liquid can be evaporated by interaction of the susceptor with the alternating magnetic field of the induction coil. Alternatively, the aerosol-forming substrate may be a solid or gel-like aerosol-forming substrate that is in thermal proximity or direct physical contact with a susceptor, wherein both the susceptor and the substrate are contained in an evaporation portion of the article. Alternatively, the susceptor may also be part of the aerosol-generating device.

In some articles, the susceptor may have a flat shape, such as a sheet-like shape, which offers a large surface to mass ratio. A large surface to mass ratio is beneficial for efficiently exploiting the heat generated by the susceptor as well as well as for enhancing the heat transfer from the susceptor to the aerosol-forming substrate.

During a user experience, the induction heating arrangement may be operated either continuously or on demand, in particular in an intermittent mode, such as on a puff by puff basis. While in the continuous operation mode the susceptor is permanently maintained at a temperature level sufficient to form a satisfactory amount of aerosol, it can be a challenge to achieve a sufficient temperature level within a short period of time if the heating system is to be operated intermittently, such as on a user's demand.

Therefore, it would be desirable to have an induction heating module, an aerosol-generating device and an aerosol-generating system for inductively heating an aerosol-forming substrate with the advantages of prior art solutions, whilst mitigating their limitations. In particular, it would be desirable to have an induction heating module, an aerosol-generating device and an aerosol-generating system for inductively heating an aerosol-forming substrate in thermal proximity or direct physical contact with a susceptor, in particular a flat susceptor, such as a sheet-like susceptor, which each allow to achieve a higher heating efficiency, in particular a sufficient temperature level within a shorter period of time.

According to the invention there is provided an induction heating module for use in an inductively heating aerosol-generating device. The induction heating module comprises at least one cylindrical-helical induction coil, in particular a single cylindrical-helical induction coil for generating an alternating magnetic field allowing to inductively heat a susceptor within an interior space of the induction coil in order to heat an aerosol-forming substrate in thermal contact or thermal proximity with the susceptor. The induction coil is formed by one or more turns of a coil wire, wherein the coil wire preferably has a circular cross-section. The induction heating module further comprises a coil support for supporting the induction coil, which comprises a support tube, in particular a cylindrical support tube, wherein the induction coil is wound around an outer circumference of the support tube. The outer circumference of the support tube comprises a wire recess pattern the coil wire is received in.

According to the invention, it has been found that the heating efficiency of an induction heating module that is intended to heat a susceptor within the interior space of a cylindrical-helical induction coil can be improved by reducing the radial distance between the induction coil and the location within the interior space of the induction coil where the susceptor is to be placed during use. In the present invention, this is achieved by providing the outer circumference of the support tube with a wire recess pattern the coil wire is received in. The wire recess pattern allows to place the induction coil closer to the location of the susceptor. The reduced radial distance leads to an increase of the magnetic field strength at the location of the susceptor which in turn causes an increase of the heating efficiency. Thus, the level of heat generated in the susceptor for a given level of power passing through the induction coil is increased, which—inter alia—allows to reach a desired temperature level within a shorter period of time. In addition, it has been experimentally found that a coil wire having a circular cross-section facilitates heating of the susceptor both in terms of heating efficiency and time to reach a desired temperature level.

Usage of a coil wire having a circular cross-section has several advantages. Coil wire having a circular cross-section is a commercial off-the-shelf and thus easily available and unexpansive. It has good winding properties. Most important, for high-frequency applications, in particular for induction heating purposes as in the present invention, it helps to reduce undesired ring/cross effects.

The efficiency of the induction heating module is further enhanced due to the use of a cylindrical-helical induction coil which advantageously allows for generating a homogeneous alternating magnetic field.

Preferably, an interior space of the support tube forms a receiving cavity for removably receiving at least a portion of an aerosol-generating article, in particular an evaporation portion of an aerosol-generating article. The evaporation portion of the article may comprise a susceptor, in particular a flat susceptor, more particularly a sheet-like susceptor, for heating an aerosol-forming substrate contained in the article by interaction of the susceptor with the alternating magnetic field of the induction coil, when article, in particular the evaporation portion is received in the interior space of the support tube. That is, the susceptor to be inductively heated by the induction coil may be part of an aerosol-generating article. Alternatively, the susceptor to be inductively heated by the induction coil may be part of an aerosol-generating device, which the induction heating module is configured to be used in/with.

Preferably, the induction coil comprises a single winding layer only, that consists of one or more turns of the coil wire. It has been found that a single-layer induction of one or more turns of a coil wire may be sufficient to achieve a sufficiently strong magnetic field at the location of the susceptor. Yet, it is also possible that the induction coil comprises more than one winding layer, for example, two or three layers.

A (center-to-center) distance between adjacent recesses of the wire recess pattern may be larger than a diameter of the coil wire. Consequently, portions of coil wire of adjacent turns do not come into contact which each other. This allows to use a coil wire without wire insulation. Nevertheless, the coil wire may be insulated coil wire. For example, the coil wire may be a coated copper wire, for example an enamel coated copper wire. In addition, the gap between adjacent turns of the induction coil serves for better heat dissipation and thus leads to less resistive power losses in the coil winding. A gap between adjacent turns also helps to reduce undesired ring/cross effects.

The coil wire may be one of a solid wire, a stranded wire and a Litz wire.

Preferably, a (center-to-center) distance between adjacent recesses of the wire recess pattern is in a range between 1.1 and 1.4, in particular 1.2 and 1.3, times a diameter of the coil wire. These ranges have proven to provide a sufficiently large distance which still allows for a compact coil design, that is, a sufficiently large number of turns per length unit.

As mentioned further above, the induction coil is formed by one or more turns of a coil wire. Preferably, the induction coil comprises 3 to 6 turns, in particular 4 to 5 turns. The number of turns does not necessarily need to be an integer number. It can also be any number between two integer numbers.

As the induction coil is driven by an AC current, the current through the coil wire only flows close to the outer surface of the coil wire. Hence, the diameter of the coil wire does not need to be large to carry a large current. In order to realize a compact coil design, that is with a sufficiently large number of turns per length unit, it may be beneficial if the coil wire has a diameter in the range between 0.8 millimeter and 1.5 millimeter, in particular between 1 millimeter and 1.2 millimeter.

Preferably, the induction coil has an axial length extension that is similar to an axial length extension of the susceptor measured in the same direction when received in the interior space of the induction coil. The induction coil may have an axial length in a range between 4 millimeter and 12 millimeter, in particular between 5 millimeter and 8 millimeter.

According to the invention, the coil wire is received in the wire recess pattern. To this extent, the wire recess pattern also servers to stabilize the coil winding. Accordingly, the wire recess pattern preferably is chosen such that it corresponds to a desired a winding pattern of the induction coil. As the induction is a cylindrical-helical induction coil, the wire recess pattern preferably is also a helical wire recess pattern.

The purpose of the wire recess pattern is to reduce the radial distance between the induction coil and the susceptor location within the interior space of the induction coil. Accordingly, the larger the depth of the recesses of the wire recess pattern, the better the magnetic field strength at the susceptor location within the interior space of the induction coil. Preferably, a depth of the recesses of the wire recess pattern in the radial direction is in a range between 0.2 and 0.8, in particular 0.3 and 0.5, times a diameter of the coil wire.

A distance in the radial direction between an inner circumference of the support tube and a bottom of the recess pattern may be in a range between 0.1 millimeter and 1 millimeter, in particular between 0.2 millimeter and 0.5 millimeter, preferably about 0.3 millimeter. Likewise, a distance in the radial direction between an inner circumference of the induction coil and an inner circumference of the support tube may be in a range between 0.1 millimeter and 1 millimeter, in particular between 0.2 millimeter and 0.5 millimeter, preferably about 0.3 millimeter. These distances values have proven to be a good compromise between a sufficiently small radial distance between the induction coil and the susceptor location and a still sufficiently large minimum wall thickness of the support tube, which still ensures a proper mechanical stability of the support tube.

In order to provide a lateral confinement of the coil winding in the axial direction, the coil support may comprise a circumferential collar at each axial end of the support tube.

At least one of the collars may comprise a recess or feedthrough opening for passing through connecting leads for the induction coil.

Where the induction heating module is intended for heating a flat, in particular sheet-like susceptor, it might be advantageous to adapt the geometry of the magnetic field within the interior space of the induction coil, where the susceptor is to be placed, to the flat shape of the susceptor. Accordingly, the outer circumference of the support tube may have a non-circular flattened transverse cross-sectional shape comprising, in particular consisting of, two opposing flat sections connected by two opposing at least partially curved sections. That is, the outside (outer face) of the support tube along its outer circumference may comprise, in particular may consist of two opposing flat outside portions connected by two opposing at least partially curved outside portions. In this configuration, the induction coil may be wound around the outer circumference of the support tube such that a transverse cross-sectional shape of the induction coil follows the non-circular flattened transverse cross-sectional shape of the outer circumference of the support tube. Advantageously, by flatting the transverse cross-sectional shape of the induction coil, the radial distance between the induction coil and the major surfaces of the flat susceptor can be reduced, given the susceptor is placed such that the major surfaces are aligned with the two opposing flat sections of the transverse cross-sectional shape of the outer circumference of the support tube. The reduced radial distance leads to an increase of the magnetic field strength at the susceptor location which in turn causes an increase of the heating efficiency. Thus, the level of heat generated in the susceptor for a given level of power passing through the induction coil is increased which-inter alia-allows to reach a desired temperature level within a shorter period of time.

The shape of the two at least partially curved sections or the shape of the two opposing at least partially curved outside portions, respectively, is chosen such as to provide a smooth transition between the two opposing flat sections or the two opposing flat outside portions, respectively, which allows for a smooth winding of the wire coil around the outer circumference of the support tube. Preferably, the at least partially curved sections is one of substantially semi-circular, substantially semi-oval, substantially semi-elliptical or substantially parabolic.

In particular, (the respective endpoints of) each of the two opposing flat sections (connecting the two opposing flat sections) may be tangent to (the respective endpoints of) the two opposing flat sections. Thus, the transition between the two opposing flat sections or the two opposing flat outside portions is particularly smooth.

Preferably, the non-circular flattened transverse cross-sectional shape is obround. Likewise, since the transverse cross-sectional shape of the induction coil follows the non-circular flattened transverse cross-sectional shape of the outer circumference of the support tube, the transverse cross-sectional shape of the induction coil may be obround as well. As used herein, the term “obround” defines a shape consisting of two semicircles connected by parallel lines tangent to their endpoints.

Accordingly, the support tube and the induction coil may have an obround-cylindrical shape, that is, the shape of a flattened cylinder with two opposing plane side wall portions parallel to each other and two opposing side hemispherical wall portions between the two opposing plane side wall portions.

Preferably, where the outer circumference of the support tube has a non-circular flattened transverse cross-sectional shape as described above, each of the above described collars—if present—may also have a non-circular flattened transverse cross-sectional shape corresponding to the non-circular flattened transverse cross-sectional shape of the outer circumference of the support tube. In particular, each collar may have obround transverse cross-sectional shape.

With regard to an easy and inexpensive manufacture, the coil support may comprise or may be made of plastics. Where the induction heating module must comply with specific regulatory requirements, the coil support may comprise or may be made of a bisphenol A-free plastic.

In addition, the induction heating module may comprise a flux concentrator arranged around the induction coil and configured to distort the alternating magnetic field of the induction coil towards the interior space of interior space of the support tube in use.

In particular, the flux concentrator may comprise a sleeve portion circumferentially surrounding the induction coil. In addition, the flux concentrator may comprise an annular protrusion portion at each axial end of the sleeve portion protruding radially inward beyond the sleeve portion, such that the induction coil is axially arranged between the annular protrusion portions. Advantageously, the annular protrusion portions at each axial end of the sleeve portion protruding radially inward beyond the sleeve portion lead to a concentration or focusing of the magnetic field within the interior space of the induction coil. Thus, the level of heat generated in the susceptor for a given level of power passing through the induction coil is increased in comparison to an induction coil having no flux concentrator or only a sleeve-shaped flux concentrator without annular protrusion portions at each axial end. This helps to increase the heating efficiency, in particular to reach a desired temperature level in a shorter time period. In addition to that, the flux concentrator acts as a magnetic shield which is capable of reducing the extent to which the magnetic field propagates beyond the induction coil.

Preferably, the flux concentrator comprises or is made of one or more layers of a flux concentrator foil. According to a preferred setup of the flux concentrator, each of the annular protrusion portions may be made of one or more layers of a flux concentrator foil, wherein the one or more layers of the annular protrusion portions extend in the radial outward direction at least to, preferably beyond an outer circumference of the induction coil. On top of the annular protrusion portions, the sleeve portion may be made of one or more layers of a flux concentrator foil which surround the induction coil and each of the annular protrusion portions. According to an alternative setup of the flux concentrator, the sleeve portion may be made of one or more layers of a flux concentrator foil surrounding the induction coil, whereas each of the annular protrusion portions may be made of one or more layers of a flux concentrator foil, ending in the radial direction flush with the outer circumference of the sleeve portion.

At least one of the annular protrusion portions, preferably the more distal annular protrusion portions may comprise a recess or feedthrough opening for passing through connecting leads for the induction coil. Where the flux concentrator is formed by winding a flux concentrator foil, the recess or feedthrough opening can be cut into the annular protrusion portion after winding the flux concentrator foil.

Where the support tube and the induction coil have a non-circular flattened transverse cross-sectional shape as described above, the flux concentrator may also have a non-circular flattened transverse cross-sectional shape corresponding to the non-circular flattened transverse cross-sectional shape of the support tube and the induction, that is, a non-circular flattened transverse cross-sectional shape comprising, in particular consisting of, two opposing flat sections connected by two opposing at least partially curved sections. In particular, the transverse cross-sectional shape of the flux concentrator may be obround.

The outer circumference of the support tube may further comprise a flux concentrator recess for each of the annular protrusion portions of the flux concentrator, in which a radially inward end of the respective annular protrusion portion is received. Due to this, the annular protrusion portions are safely supported which helps to prevent the flux concentrator from being displace which otherwise could lead to an undesired change in the inductance of the induction coil and an undesired change of the magnetic field density in the interior space of the induction coil.

The present invention also relates to an inductively heating aerosol-generating device for use with an aerosol-generating article, wherein the article comprises an aerosol-forming substrate to be heated by interaction of a susceptor with an alternating magnetic field provided by the aerosol-generating device. The aerosol-generating device a comprises an induction heating module according to the present invention and as described herein.

As used herein, the term “aerosol-generating device” is used to describe an electrically operated device that is capable of interacting with at least one aerosol-generating article comprising an aerosol-forming substrate, in particular an aerosol-forming liquid, and a susceptor such as to generate an aerosol by inductively heating the substrate via interaction of the susceptor with an alternating magnetic field provided by the device. Preferably, the aerosol-generating device is a puffing device for generating an aerosol that is directly inhalable by a user through the user's mouth. In particular, the aerosol-generating device is a hand-held aerosol-generating device.

The aerosol-generating device may comprise a device housing which the induction heating module according to the present invention are located or arranged in.

The aerosol-generating device, in particular the device housing may comprise an insertion opening giving access to the interior space of the induction coil or the interior space of the support tube of the induction heating module in order to enable insertion of an aerosol-generating article therein.

The aerosol-generating device may further comprise a receiving cavity for removably receiving at least a portion, in particular an evaporation portion of the aerosol-generating article. The receiving cavity may be located at least partially within the interior space of the induction coil or the interior space of the support tube of the induction heating module. In particular, the receiving cavity may be formed at least partially by the interior space of the induction coil or the support tube of the induction heating module, in particular by the interior space of the support tube of the induction heating module. The induction coil may be arranged such as to surround at least a portion of the receiving cavity, in particular such as to surround at least the evaporation portion of the aerosol-generating article, when it is received in the receiving cavity.

The aerosol-generating device may further comprise an alternating current (AC) generator. The AC generator may be powered by a power supply, in particular a DC power suppl of the device. The AC generator is operatively coupled to the at least one induction coil. In particular, the induction coil may be integral part of the AC generator. The AC generator is configured to generate a high frequency oscillating current to be passed through the induction coil for generating a varying magnetic field. The AC current may be supplied to the induction coil continuously following activation of the system or may be supplied intermittently, such as on a puff by puff basis.

Preferably, the aerosol-generating device comprises a DC/AC converter connectable to a DC power supply, which may also be part of the aerosol-generating device

The DC/AC converter may include an LC network. For example, the DC/AC converter may comprise a power amplifier, in particular a switching power amplifier, more particularly a single-ended switching power amplifier, preferably one of a Class-C power amplifier or a Class-D power amplifier or Class-E power amplifier. In particular, the DC/AC converter may comprise at least one transistor switch, in particular a single transistor switch, at least one transistor switch driver circuit and at least one LC network. The LC network may comprise a series connection of a capacitor and an inductor, wherein the inductor is the cylindrical-helical induction coil of the inductive heating module according to the present invention, which is used to generate the alternating magnetic field for heating the susceptor of the article that is to be received in the interior space of the induction coil. The LC network may further comprise a shunt capacitor in parallel to the transistor switch. In addition, DC/AC converter may comprise a choke inductor for supplying a DC supply voltage from the DC power supply.

The aerosol-generating device preferably is configured to generate a high-frequency varying magnetic field. As referred to herein, the high-frequency varying magnetic field may have a frequency in a range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

The aerosol-generating device may further comprise a controller configured to control operation of the device. In particular, the controller may be configured to control heating of the aerosol-forming substrate to a pre-determined operating temperature. Depending on at least one of the type of the aerosol-forming substrate to be heated, the configuration of the susceptor and the arrangement of the susceptor relative to the aerosol-forming substrate, the operating temperature may be in a range between 180 degree Celsius and 370 degree Celsius, in particular between 180 degree Celsius and 240 degree Celsius or between 280 degree Celsius and 370 degree Celsius.

The controller may comprise a microprocessor, for example a programmable microprocessor, a microcontroller, or an application specific integrated chip (ASIC) or other electronic circuitry capable of providing control. The controller may comprise further electronic components, in particular parts of the alternating current (AC) generator, such as parts of the DC/AC inverter and/or the power amplifier. In particular, the inductive heating module may be—at least partially—part of the controller.

The aerosol-generating device may further comprise a puff detector, such as a microphone or a pressure sensor, for detecting a user's puff, that is, the onset of a user experience when a user starts puffing on the device. The puff detector may be operatively connected to the controller. By this, the detection of the occurrence of a puff by means of the puff detector may trigger the power delivery to the induction coil for generating an aerosol. That is, the controller may be configured to start operation of the heating arrangement, in particular generation of an alternating magnetic field in response to the puff detector detecting the occurrence of a user's puff.

The aerosol-generating device may comprise a power supply, in particular a DC power supply configured to provide a DC supply voltage and a DC supply current to the inductive heating module. Preferably, the power supply is a battery such as a lithium iron phosphate battery. The power supply may have sufficient capacity to allow for the continuous generation of aerosol for a period of around six minutes or for a period that is a multiple of six minutes. In Likewise, the power supply may have sufficient capacity to allow for a predetermined number of puffs or discrete activations of the inductive heating module.

The susceptor used for heating the aerosol-forming substrate by interaction of the susceptor with the alternating magnetic field provided by the aerosol-generating device may be part of the article the device is configured for use with. In particular, the susceptor may be arranged in an evaporation portion of the article. In this configuration, the interior space of the induction coil, the interior space of the support tube of the induction heating module and/or the receiving cavity of the aerosol-generating device preferably is configured for removably receiving at least the evaporation portion of the aerosol-generating article.

Alternatively, the susceptor used for heating the aerosol-forming substrate by interaction of the susceptor with the alternating magnetic field provided by the aerosol-generating device may be part of the aerosol-generating device itself. That is, the aerosol-generating device according to the present (first) aspect may comprise the susceptor for heating the aerosol-forming substrate.

In either configuration, the susceptor preferably is a flat susceptor, more particularly a sheet-like susceptor. The flat, in particular sheet-like susceptor may comprise or may be a susceptor blade, a susceptor strip or a susceptor plate. In particular where the substrate is a liquid, that is, an aerosol-forming liquid, the susceptor may comprise or may be a mesh susceptor. It is also possible that the susceptor may comprise or may be susceptor sleeve, a susceptor cup, a cylindrical susceptor or a tubular susceptor.

Further features and advantages of the aerosol-generating device according to this first aspect of the invention have been described with regard to the induction heating module of the present invention, and equally apply.

The present invention further relates to an aerosol-generating system comprising an aerosol-generating device according to the present invention and as described herein, and an aerosol-generating article for use with the aerosol-generating device, wherein the article comprises an aerosol-forming substrate to be heated by interaction of a susceptor with an alternating magnetic field provided by the aerosol-generating device.

As used herein, the term “aerosol-generating system” refers to the combination of an aerosol-generating article as further described herein with an aerosol-generating device according to the invention and as described herein. In the system, the article and the device cooperate to generate a respirable aerosol.

As used herein, the term “aerosol-generating article” refers to an article comprising at least one aerosol-forming substrate that, when heated, releases volatile compounds that can form an aerosol. Preferably, the aerosol-generating article is a heated aerosol-generating article. That is, an aerosol-generating article which comprises at least one aerosol-forming substrate that is intended to be heated rather than combusted in order to release volatile compounds that can form an aerosol. The aerosol-generating article may be a consumable, in particular a consumable to be discarded after a single use. Preferably, the article may include a liquid aerosol-forming substrate, that is, an aerosol-forming liquid. Alternatively, the article may include a solid aerosol-forming substrate or a gel-like aerosol-forming substrate, or a combination thereof.

As used herein, the term “aerosol-forming substrate” in general denotes a substrate formed from or comprising an aerosol-forming material that is capable of releasing volatile compounds upon heating in order to generate an aerosol. The aerosol-forming substrate is intended to be heated rather than combusted to release the aerosol-forming volatile compounds. The aerosol-forming substrate may be a solid aerosol-forming substrate, a liquid aerosol-forming substrate, a gel-like aerosol-forming substrate, or any combination thereof. Preferably, the aerosol-forming substrate is a liquid aerosol-forming substrate, that is an aerosol-forming liquid. The aerosol-forming liquid may contain both, solid and liquid aerosol-forming material or components. The aerosol-forming substrate, in particular the aerosol-forming liquid may comprise a tobacco-containing material containing volatile tobacco flavor compounds, which are released from the substrate upon heating. Alternatively or additionally, the aerosol-forming substrate, in particular the aerosol-forming liquid may comprise a non-tobacco material. The aerosol-forming substrate, in particular the aerosol-forming liquid may further comprise an aerosol former. Examples of suitable aerosol formers are glycerin and propylene glycol. The aerosol-forming substrate, in particular the aerosol-forming liquid may also comprise other additives and ingredients, such as nicotine or flavourants. In particular, the aerosol-forming liquid may include water, solvents, ethanol, plant extracts and natural or artificial flavors. The aerosol-forming liquid may be a water-based aerosol-forming liquid or an oil-based aerosol-forming liquid. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

As described above with regard to the aerosol-generating device according to the present invention, the susceptor for heating the aerosol-forming substrate may be either part of the aerosol-generating device or the aerosol-generating article. That is, either the aerosol-generating device or the aerosol-generating article comprises the susceptor for heating the aerosol-forming substrate.

In the latter case, the aerosol-generating article may comprise an evaporation portion, wherein the susceptor for heating the aerosol-forming substrate is arranged in the evaporation zone. In this configuration, an interior space of the induction coil and/or the interior space of the support tube of the induction heating module of the aerosol-generating device preferably is configured for removably receiving at least the evaporation portion of the aerosol-generating article.

As used herein, the term “susceptor” refers to an element that is capable to convert electromagnetic energy into heat when subjected to a varying magnetic field. This may be the result of at least one of hysteresis losses or eddy currents which are induced in the susceptor, depending on the electrical and magnetic properties of the susceptor material. Hysteresis losses occur in ferromagnetic or ferrimagnetic susceptors due to magnetic domains within the susceptor material being switched under the influence of a varying magnetic field. Eddy currents may be induced if the susceptor is electrically conductive. In case of an electrically conductive ferromagnetic or ferrimagnetic susceptor, heat can be generated due to both, eddy currents and hysteresis losses.

Accordingly, the susceptor may be formed from any material that can be inductively heated to a temperature sufficient to generate an aerosol from the aerosol-forming substrate. Preferred susceptors comprise a metal or carbon. A preferred susceptor may comprise a ferromagnetic material, for example ferritic iron, or a ferromagnetic steel or stainless steel. A suitable susceptor may be, or comprise, aluminum. Preferred susceptors may be formed from 400 series stainless steels, for example grade 410, or grade 420, or grade 430 stainless steel.

The susceptor may comprise a variety of geometrical configurations, depending—inter alia—on the type of the aerosol-forming substrate.

The susceptor may comprise or may be a susceptor pin, a susceptor rod, a susceptor blade, a susceptor strip or a susceptor plate. Likewise, the susceptor may comprise or may be a susceptor sleeve, a susceptor cup, a cylindrical susceptor or a tubular susceptor. Preferably, the susceptor is a flat susceptor, more particularly a sheet-like susceptor.

In particular where the substrate is a liquid, that is, an aerosol-forming liquid, the susceptor may comprise or may be a filament susceptor, a mesh susceptor, a wick susceptor. In any of these configurations, the susceptor advantageously is capable to perform both functions: wicking (conveying) and heating the aerosol-forming liquid. Accordingly any of the aforementioned configurations, the susceptor may be considered a liquid-conveying susceptor.

Where the aerosol-forming substrate is a liquid substrate, the article may comprise a liquid reservoir for storing aerosol-forming liquid. Preferably, the susceptor is in fluid communication with the liquid reservoir in which the aerosol-forming liquid is stored.

Further features and advantages of the aerosol-generating system have been described with regard to the induction heating module and the aerosol-generating device of the present invention, and equally apply.

As used herein, the terms “radial” and “axial” refer to the cylindrical geometry of the cylindrical induction coil.

Example Ex1: An induction heating module for use in an inductively heating aerosol-generating device, the induction heating module comprising:
a cylindrical-helical induction coil for generating an alternating magnetic field allowing to inductively heat a susceptor within an interior space of the induction coil in order to heat an aerosol-forming substrate in thermal contact or thermal proximity with the susceptor, wherein the induction coil is formed by one or more turns of a coil wire, wherein the coil wire preferably has a circular cross-section;
a coil support for supporting the induction coil comprising a support tube, wherein the induction coil is wound around an outer circumference of the support tube, and wherein an interior space of the support tube forms a receiving cavity for removably receiving at least an evaporation portion of an aerosol-generating article, the evaporation portion comprising a susceptor for heating an aerosol-forming substrate contained in the article by interaction of the susceptor with the alternating magnetic field of the induction coil, when the evaporation portion is received in the interior space of the support tube; wherein the outer circumference of the support tube comprises a wire recess pattern the coil wire is received in.

Example Ex1a: The induction heating module according to example Ex1, wherein an interior space of the support tube forms a receiving cavity for removably receiving at least a portion of an aerosol-generating article, in particular an evaporation portion of an aerosol-generating article, wherein the evaporation portion of the article preferably comprises a susceptor, in particular a flat susceptor, more particularly a sheet-like susceptor, for heating an aerosol-forming substrate contained in the article by interaction of the susceptor with the alternating magnetic field of the induction coil.

Example Ex2: The induction heating module according to any one of example Ex1 or example Ex1a, wherein a distance between adjacent recesses of the wire recess pattern is larger than a diameter of the coil wire.

Example Ex3: The induction heating module according to any one of the preceding examples, wherein a distance between adjacent recesses of the wire recess pattern is in a range between 1.1 and 1.4, in particular 1.2 and 1.3, times a diameter of the coil wire.

Example Ex4: The induction heating module according to any one of the preceding examples, wherein the induction coil comprises 3 to 6 turns, in particular 4 to 5 turns.

Example Ex5: The induction heating module according to any one of the preceding examples, wherein the coil wire has a diameter in the range between 0.8 millimeter and 1.5 millimeter, in particular between 1 millimeter and 1.2 millimeter.

Example Ex6: The induction heating module according to any one of the preceding examples, wherein the wire recess pattern corresponds to a winding pattern of the induction coil.

Example Ex7: The induction heating module according to any one of the preceding examples, wherein the coil wire is one of a solid wire, a stranded wire and a Litz wire.

Example Ex8: The induction heating module according to any one of the preceding examples, wherein the wire recess pattern is a helical wire recess pattern.

Example Ex9: The induction heating module according to any one of the preceding examples, wherein a depth of the recesses of the wire recess pattern in the radial direction is in a range between 0.2 and 0.8, in particular 0.3 and 0.5, times a diameter of the coil wire

Example Ex10: The induction heating module according to any one of the preceding examples, wherein a distance in the radial direction between an inner circumference of the support tube and a bottom of the recess pattern is in a range between 0.1 millimeter and 1 millimeter, in particular between 0.2 millimeter and 0.5 millimeter, preferably about 0.3 millimeter.

Example Ex11: The induction heating module according to any one of the preceding examples, wherein a distance in the radial direction between an inner circumference of the induction coil and an inner circumference of the support tube is in a range between 0.1 millimeter and 1 millimeter, in particular between 0.2 millimeter and 0.5 millimeter, preferably about 0.3 millimeter.

Example Ex12: The induction heating module according to any one of the preceding examples, wherein the coil support comprises a circumferential collar at each axial end of the support tube.

Example Ex13: The induction module according to example Ex12, wherein at least one of the collars comprises a recess or feedthrough opening for passing through connecting leads for the induction coil.

Example Ex14: The induction module according to any one of the preceding examples, wherein the coil support comprises or is made of plastics, in particular a bisphenol A-free plastic.

Example Ex15: The induction module according to any one of the preceding examples, wherein the outer circumference of the support tube comprises two flux concentration recesses for receiving at least a respective portion of a flux concentrator, wherein the wire recess pattern is axially arranged between two flux concentration recesses.

Example Ex16: The induction module according to any one of the preceding examples, wherein an outer circumference of the support tube has a non-circular flattened transverse cross-sectional shape comprising, in particular consisting of, two opposing flat sections connected by two opposing at least partially curved sections, and wherein the induction coil is wound around the outer circumference of the support tube such that a transverse cross-sectional shape of the induction coil follows the non-circular flattened transverse cross-sectional shape of the outer circumference of the support tube.

Example Ex17: The induction module according to example Ex16, the non-circular flattened transverse cross-sectional shape of the outer circumference of the support tube comprises a minor axis of symmetry and a major axis of symmetry.

Example Ex18: The induction heating module according to example Ex17, wherein a ratio of a maximum distance along the major axis of symmetry between the two opposing at least partially curved sections to a maximum distance along the minor axis of symmetry between the two opposing flat sections is in a range between 1.2 and 3, in particular between 1.5 and 2.5.

Example Ex19: The induction heating module according to any one of example Ex17 or example Ex18, wherein a maximum distance along the minor axis of symmetry between the two opposing flat sections is in a range between 4 millimeter and 7 millimeter, in particular between 5 millimeter and 6 millimeter.

Example Ex20: The induction heating module according to any one of examples Ex17 to Ex19, wherein a maximum distance along the major axis of symmetry between the two opposing at least partially curved sections is in a range between 7 millimeter and 10 millimeter, in particular between 8 millimeter and 9 millimeter.

Example Ex21: The induction heating module according to any one of examples Ex16 to Ex20, wherein the two opposing flat sections are parallel to each other.

Example Ex22: The induction heating module according to any one of examples Ex16 to Ex21, wherein each of the two opposing flat sections is a substantially straight line.

Example Ex23: The induction heating module according to any one of examples Ex16 to Ex22, wherein each of the at least partially curved sections is one of substantially semi-circular, substantially semi-oval, substantially semi-elliptical or substantially parabolic.

Example Ex24: The induction heating module according to any one of examples Ex16 to Ex23, wherein the non-circular flattened transverse cross-sectional shape of the outer circumference of the support tube is obround.

Example Ex25: The induction heating module according to any one of examples Ex16 to Ex24, wherein the transverse cross-sectional shape of the induction coil is obround.

Example Ex26: An inductively heating aerosol-generating device for use with an aerosol-generating article, the article comprising an aerosol-forming substrate to be heated by interaction of a susceptor with an alternating magnetic field provided by the aerosol-generating device, wherein the device comprises an induction heating module according to any one of the preceding examples.

Example Ex27: The inductively heating aerosol-generating device according to example Ex26, wherein the device further comprises the susceptor for heating the aerosol-forming substrate.

Example Ex28: The inductively heating aerosol-generating device according to example Ex27, wherein the susceptor is a flat susceptor, more particularly a sheet-like susceptor.

Example Ex29: An aerosol-generating system comprising an aerosol-generating device according to any one of examples Ex26 to Ex28 and an aerosol-generating article for use with the aerosol-generating device, the article comprising an aerosol-forming substrate to be heated by interaction of a susceptor with an alternating magnetic field provided by the aerosol-generating device.

Example Ex30: The aerosol-generating system according to example Ex29, wherein either the aerosol-generating device or the aerosol-generating article comprises the susceptor for heating the aerosol-forming substrate.

Example Ex31: The aerosol-generating system according to example Ex30, wherein the susceptor is a flat susceptor, more particularly a sheet-like susceptor.

Example Ex32: The aerosol-generating system according to any one of example Ex29 to Ex31, wherein the article comprises an evaporation portion, wherein the susceptor for heating the aerosol-forming substrate is arranged in the evaporation zone.

Example Ex33: The aerosol-generating system according to example Ex32, wherein an interior space of the induction coil and/or the interior space of the support tube of the induction heating module is configured for removably receiving at least the evaporation portion of the aerosol-generating article.

Examples will now be further described with reference to the figures in which:

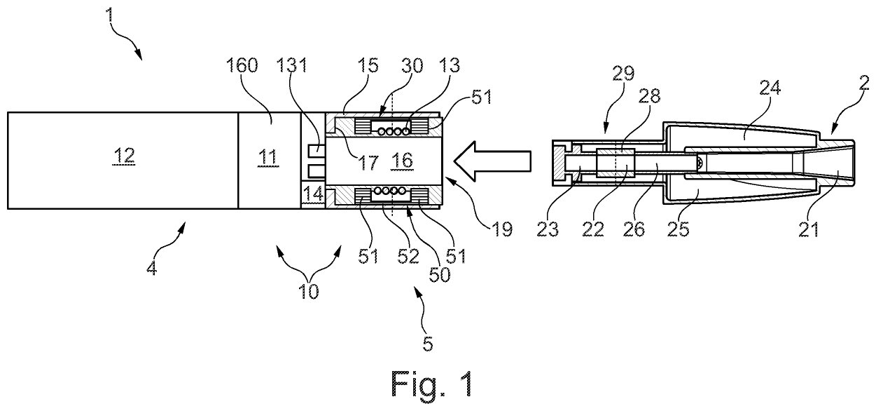

FIG. 1 shows an exemplary embodiment of an aerosol-generating system according to the present invention in a longitudinal cross-sectional view;

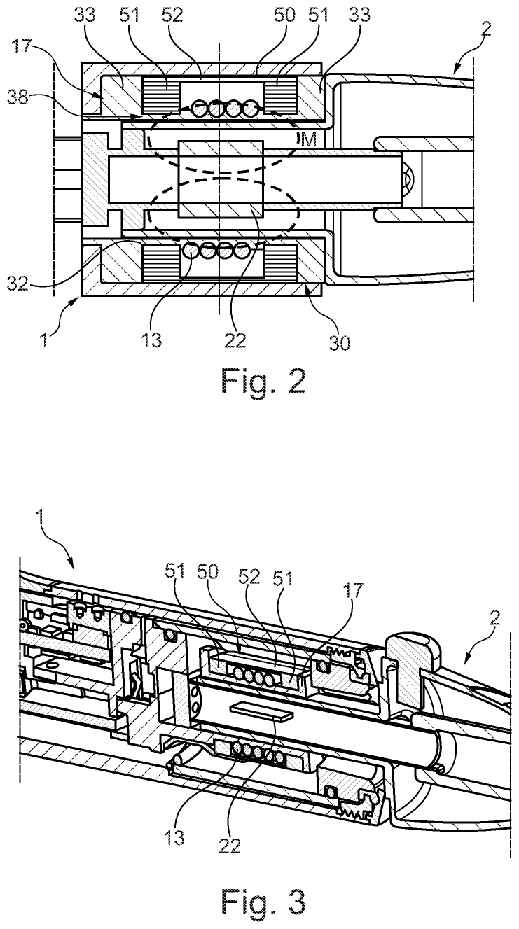

FIG. 2 shows a detailed longitudinal cross-sectional view of the aerosol-generating system according to FIG. 1;

FIG. 3 shows details of the aerosol-generating system according to FIG. 1 in a perspective longitudinal cross-sectional view;

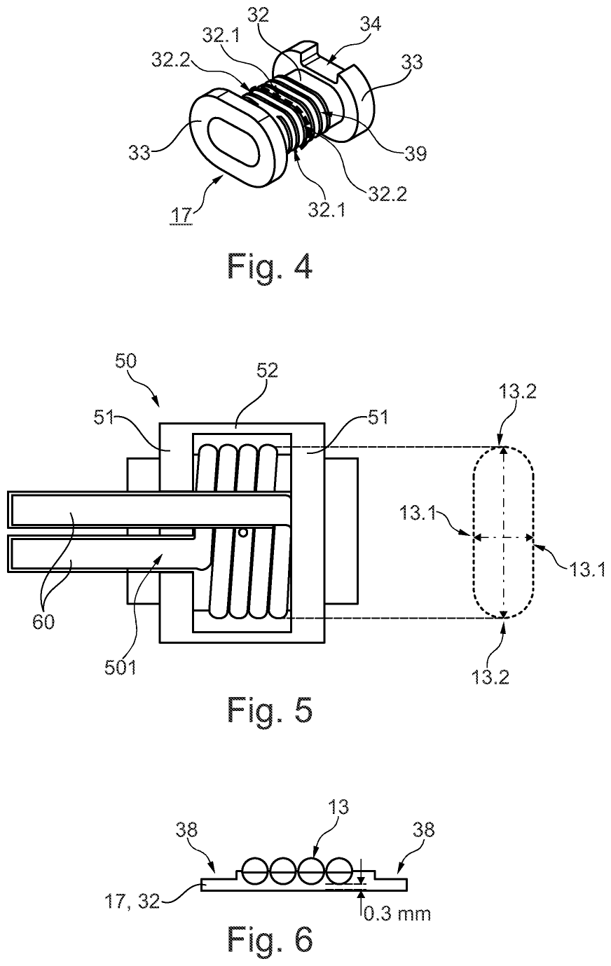

FIG. 4 shows details of a coil support used in the aerosol-generating device according FIG. 1;

FIG. 5 shows details of the inductive heating arrangement used in the aerosol-generating device according FIG. 1;

FIG. 6 shows further details of the coil support used in the aerosol-generating device according FIG. 1;

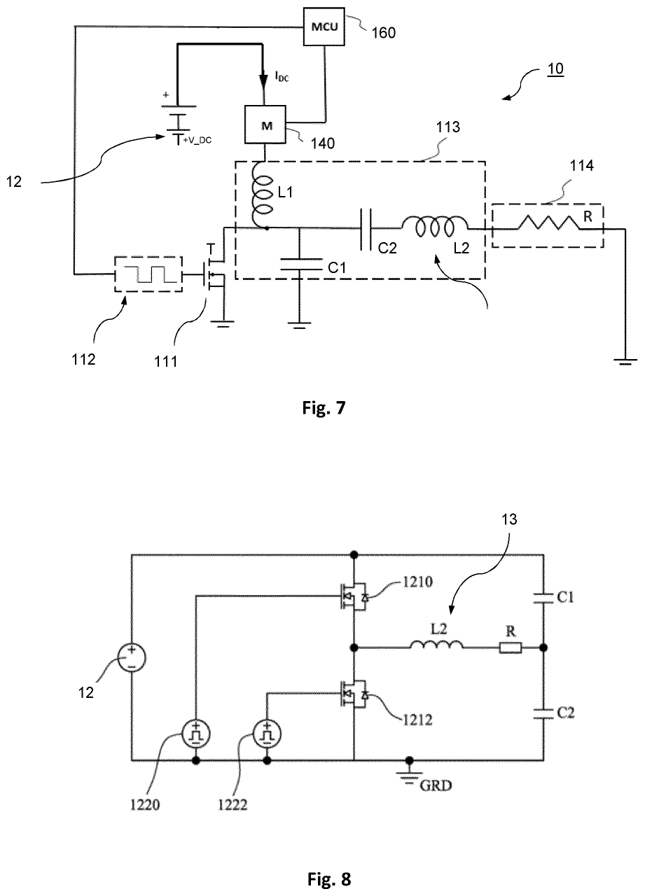

FIG. 7 shows details of a first embodiment of a power supply electronics that can be used in the aerosol-generating device according FIG. 1; and

FIG. 8 shows details of a second embodiment of a power supply electronics that can be alternatively used in the aerosol-generating device according FIG. 1.

FIGS. 1-3 show a schematic cross-sectional illustration of an aerosol-generating system 1 according to an exemplary embodiment of the present invention. The system 1 is configured to generate an inhalable aerosol by inductively heating a susceptor that is in thermal contact with a liquid aerosol-forming substrate 25, hereafter also denoted as aerosol-forming liquid 25. The system 1 comprises two main components: an aerosol-generating article 2 and an aerosol-generating device 1 for use with the article 2. While the article 2 includes a susceptor 22 and the aerosol-forming liquid 25 to be heated, the device 1 comprises a receiving cavity 16 for receiving the article 2, and an inductive heating arrangement 10 that is configured to generate an alternating magnetic field for inductively heating the susceptor 22 and thus for vaporizing the aerosol-forming liquid 25 within the article 2 when the latter is inserted into the cavity 16 of the device 1.

With reference to FIG. 1, which shows the device 1 and the article 2 decoupled from each other, the aerosol generating device 1 comprises a substantially rod-shaped main body having a substantially cylindrical device housing 15. Within a distal portion 4, the device 1 comprises a power supply 12, for example a lithium ion battery, and an electric circuitry 11 including a controller 160 for controlling operation of the device 1, in particular for controlling the heating process. Within a proximal portion 5 opposite to the distal portion 4, the device 1 comprises the receiving cavity 16 and at least parts of the inductive heating arrangement 10. The receiving cavity 16 is an open-ended cavity comprising an insertion opening 19 at the proximal end of device 1 to enable insertion of the article 2 into the receiving cavity 16.

The inductive heating arrangement 10 comprises an induction coil 13 for generating an alternating magnetic field within the cavity 16. The induction coil 13 is a cylindrical-helical coil circumferentially surrounding the cylindrical receiving cavity 16. In the present embodiment, the induction coil 13 has an axial length of about 8 millimeter and is formed by a single layer of 4.25 turns of a coil wire that has a circular cross-section. The turns of the induction coil 13 extend along the length extension of the cavity 16. Preferably, there is a gap between adjacent turns of the induction coil 13. That is, a pitch of the helical induction coil 13 may be larger than a diameter of the coil wire. As a consequence, the coil wire of adjacent turns does not come into contact which each other, which allows to use a coil wire without wire insulation. Nevertheless, the coil wire in the present embodiment is an enamel coated copper wire having a diameter of 1.1 millimeter. In addition, the gap between adjacent turns of the induction coil serves for better heat dissipation and thus leads to less resistive power losses in the coil winding. In the present embodiment, a (center-to-center) distance between adjacent portions of the coil wire of adjacent turns is about 1.1 times the diameter of the coil wire. These ranges have proven to provide a sufficiently large distance which still allows for a compact coil design, that is, a sufficiently large number of turns per length unit.

The induction coil 13 is part of an induction module 30, which in addition to the induction coil 13 further comprises a coil support 17 arranged within the device housing 15 for supporting the induction coil 1 . Details of the coil support 17 are shown in FIG. 4. The coil support 17 comprises a cylindrical support tube 32 and a circumferential collar 33 at each axial end of the support tube 32. The more distal collar 33 comprises a recess or feedthrough opening 34 for passing through connecting leads 60 to the induction coil 13 as shown in FIG. 5. As can be seen from FIGS. 1-3, the interior space of the support tube 32 forms at least partially the receiving cavity 16 of the device 1 for removably receiving at least a portion of the aerosol-generating article 2. That is, the inner surface along the inner circumference of the support tube 32 forms at least a portion of an inner surface of the receiving cavity 16. With regard to an easy and inexpensive manufacture, the coil support 17 may be made of plastics. Where the induction heating module 30 must comply with specific regulatory requirements, the coil support 17 may be made, for example, of a bisphenol A-free plastic.

In addition to the induction coil 13, the inductive heating arrangement 10 comprises a power supply electronics which may be integrated at least partially in the electric circuitry 11 and coupled to the induction coil 13 via connection electrical pads 131 (see FIG. 1). In combination with the induction coil 13, the power supply electronics serves to generate a high-frequency alternating current passing through the induction coil 13, which causes the induction coil 31 to generate a high-frequency varying magnetic field within the interior space of the induction coil 12 and thus within the cavity 16 as indicated by the dashed lines in FIG. 2. The frequency of the high-frequency varying magnetic field may be in a range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz). As will be described in more detail further below, the alternating magnetic field is used to induce at least one of heat generating eddy currents or hysteresis losses in the susceptor 22 of the article 2 in order to vaporize the aerosol-forming liquid 25 contained in the article 2.

Next to the device 1, FIG. 1 also shows details of the aerosol-generating article 2. In the present embodiment, the article 2 is a cartridge having a mushroom-type shape that is to be couplable to the device 1. At a distal end, the article 2 comprises an elongate evaporation portion 29 configured to be inserted into the receiving cavity 16 of the device 1, as shown in FIG. 2 and FIG. 3. Within the evaporation portion 29, the article 2 comprises the susceptor 22 that is arranged within the article 2 such that the susceptor 22 is located within the interior space of the induction coil 13, when the evaporation portion 29 of the article 2 is inserted into the cavity 16. Thus, the susceptor 22 may experience the alternating magnetic field generated by the induction coil 13 during operation of the heating arrangement 10 in order to be heated up.

In the present embodiment, the susceptor 22 is a flat, sheet-like mesh made of an inductively heatable ferromagnetic stainless steel. Accordingly, the susceptor 22 may also be denoted as a sheet-like mesh susceptor 22 which is capable to perform both functions: wicking (conveying) and heating the aerosol-forming liquid 25. As the material of the susceptor 22 at hand is both electrically conductive and magnetic, the alternating electromagnetic field of the induction coil 13 can induces both heat generating eddy currents and hysteresis losses in the susceptor material.

The susceptor mesh 22 is in fluid communication with the aerosol-forming liquid 25 contained in a reservoir 24 of the article 2 by means of a wicking porous element 28. The wicking porous element 28 is in direct contact with the liquid 25 in the reservoir 24 and configured to transport the liquid 25 to the mesh susceptor 22. Thus, the susceptor mesh 22 is continuously humidified. Upon inserting the article 2 into the cavity 16 (see FIG. 2 and FIG. 3) and activating the heating arrangement 10, the mesh susceptor 22 is heated up until reaching a temperature sufficient to vaporize the aerosol-forming liquid 25 in contact the mesh susceptor 22.

As can be further seen particularly in FIG. 1, the mesh susceptor 22 is arranged within an airflow channel 26 that passes through the article 2 along its center axis. The airflow channel 26 has an air inlet at the distal end of the article 2 and an outlet at a proximal end of the article 2: The outlet is formed by a mouthpiece 21 which a user can puff on. Hence, when a user takes a puff at the mouthpiece 21 in use of the system, air is entrained into the airflow channel 26 via the air inlet and passes along the mesh susceptor 22. There, vaporized material of the aerosol-forming liquid is entrained into the airflow through the airflow channel 26. Subsequently, while passing further downstream in the airflow channel 26 towards the mouthpiece 21, the airflow including the vaporized material cools down such as to form an aerosol escaping the article 2 through the outlet at the mouthpiece 21.

The aerosol-generating device 1 according to the present embodiment further comprises a puff detector 14 for detecting a user's puff. The puff detector 14 is operatively connected to the power supply electronics such that the detection of the occurrence of a puff by means of the puff detector 14 triggers the power delivery to the induction coil 13 for generating an aerosol. To this extent, the aerosol-generating device 1 according to the present embodiment may be denoted as a puff-on-demand device. Once a user stops puffing, the power delivery to the induction coil is interrupted in order not to generate unnecessarily unused aerosol. That is, the induction heating arrangement is operated intermittently on a user's demand.

While in a continuous operation mode the susceptor would be permanently maintained at a temperature level sufficient to form a satisfactory amount of aerosol, it can be a challenge to achieve a sufficient temperature level within a short period of time if the heating arrangement is to be operated intermittently, such as on a user's demand (puff-on-demand).

In order to achieve a higher heating efficiency, in particular a sufficient temperature level within a shorter period of time, it has been found that it would be advantageous with respect to the flat, sheet-like shape of the susceptor 22 to adapt the geometry of the magnetic field within the interior space of the induction coil 13, where the susceptor 22 is to be placed, to the flat shape of the susceptor 22. In particular, it has been found that by flatting the transverse cross-sectional shape of the induction coil 13, the radial distance between the induction coil 13 and the major surfaces of the flat susceptor 22 can be reduced. The reduced radial distance leads an increase of the magnetic field strength at the susceptor location which in turn causes an increase of the heating efficiency. Thus, the level of heat generated in the susceptor for a given level of power passing through the induction coil is increased which-inter alia-allows to reach a desired temperature level within a shorter period of time. Accordingly, in the present embodiment, the outer circumference of the support tube 32 has a non-circular flattened transverse cross-sectional shape (see dashed line in FIG. 4) consisting of two opposing flat sections 32.1 connected by two opposing at least partially curved sections 32.2. Since the induction coil 13 is wound around the outer circumference of the support tube 32, the transverse cross-sectional shape of the induction coil 13 follows the non-circular flattened transverse cross-sectional shape of the outer circumference of the support tube 32. That is, the cylindrical-helical induction coil 13 also has a non-circular flattened transverse cross-sectional shape (see dotted line on the right in FIG. 5) consisting of two opposing flat sections 13.1 connected by two opposing at least partially curved sections 13.2.

In the present embodiment, the non-circular flattened transverse cross-sectional shape of the support tube 32 and the induction coil 13 is obround, that is a shape consisting of two semicircles 13.2, 32.2 connected by parallel lines 13.1, 32.1 tangent to their endpoints. Accordingly, the induction coil 13 and the support tube 17 have an obround-cylindrical shape.

Due to the parallel and semi-circular portions of the obround shape, the non-circular flattened transverse cross-sectional shape of the induction coil 13 and the support tube 32 comprises a minor axis of symmetry and a major axis of symmetry. As indicated by the dashed-dotted arrows with respect to the induction coil 13 in FIG. 5 on the right, the minor axis of symmetry extends between the two opposing flat sections 13.1 of the induction coil 13, whereas the major axis of symmetry extends between the two opposing curved sections 13.2 of the induction coil. Preferably, a ratio of a maximum distance along the major axis of symmetry between the two opposing at least partially curved sections 13.2, 32.2 to a maximum distance along the minor axis of symmetry between the two opposing flat sections 13.1, 32.1 is in a range between 1.2 and 3, in particular between 1.5 and 2.5. These ratios are particularly advantageous with regard to a proper match between the geometry of the magnetic field and a flat shape of the susceptor 22 to be heated.

In order to further improve the heating efficiency, the inductive heating arrangement 10 of the present embodiment comprises a flux concentrator 50 which is arranged around the induction coil 13 and configured to distort the alternating magnetic field of the induction heating arrangement 10 towards the interior space of the induction coil 13 during use. For this purpose, the flux concentrator 50 has a specific configuration comprising a sleeve portion 52 circumferentially surrounding the induction coil 13 and in addition an annular protrusion portion 51 at each axial end of the sleeve portion 52 protruding radially inward beyond the sleeve portion 51, such that the induction coil 13 is axially arranged between the annular protrusion portions 51, as can be particularly seen in FIG. 1 and FIG. 2. Hence, as seen in a longitudinal cross-section through the flux concentrator 50 along a length axis of the induction coil 13 (see FIG. 1 and FIG. 2), the flux concentrator 50 has a U- or C-shape, wherein the sleeve portion 52 is part of the base of the U- or C-shape and the annular protrusion portions 51 are part of the arms or legs of the U- or C-shape. To this extent, it has been found that the density of the magnetic field at the location of the susceptor 22 can be increased by distorting the magnetic field towards the interior space of the induction coil 13 using a flux concentrator 50 which is shaped as described above. In particular, the annular protrusion portions 51 at each axial end of the sleeve portion 52 protruding radially inward beyond the sleeve portion 52 lead to a concentration or focusing of the magnetic field within the interior space of the induction coil 13. Thus, the level of heat generated in the susceptor 22 for a given level of power passing through the induction coil 13 is increased in comparison to an induction coil having no flux concentrator or only a sleeve-shaped flux concentrator without annular protrusion portions at each axial end. In addition to that, the flux concentrator 50 acts as a magnetic shield which is capable of reducing the extent to which the magnetic field propagates beyond the induction coil 13. Thus, the flux concentrator 50 can help to reduce undesired heating of other susceptive parts of the system or susceptive items external to the device 1.

While the annular protrusion portions 51 should extend radially inward beyond an outer circumference of the induction coil 13 in order to ensure a sufficient concentration of the magnetic field, it may be sufficient, if the annular protrusion portions 51 extend radially inward at most to an inner circumference of the induction coil 13, that is, if the annular protrusion portions do not protrude radially inward beyond the inner circumference of the induction coil 13.

In the present embodiment, the flux concentrator 50 is built up from a flux concentrator foil. More particularly, each of the annular protrusion portions 51 is made of a flux concentrator foil which is spirally wound up on the coil support 17 in a plurality of layers such as to extend radially outward beyond an outer circumference of the induction coil 13. On top of the annular protrusion portions 51, the sleeve portion 52 is formed of several layers of the same flux concentrator foil material such as to surround the induction coil 13 and each of the annular protrusion portions 51. As an example, a flexible three-layer ferrite sheet comprising a ferrite layer sandwiched between an adhesive layer and a cover layer, that is available from the company Laird under the product name MHLL6060-300, can be used as flux concentrator foil. MHLL6060-300 has a foil thickness of about 90 micrometer, a real magnetic permeability of about 130 and an imaginary magnetic permeability of about 5 at a frequency of 13.56 MHz. At hand, each of the annular protrusion portions 51 shown in FIGS. 1-3 has a height dimension (in the radial direction) of 2 millimeter and a width dimensions (in the axial direction) of 2 millimeter. The sleeve portion 52 has a thickness dimension (in the radial direction) of about 180 micrometer and a width dimensions (in the axial direction) of 10 millimeter. Hence, using a foil material with a foil thickness of 90 micrometer requires about 22 windings to form the annular protrusion portions 51 of 2 millimeter height, and about 2 windings to form the sleeve portion 52 of 180 micrometer thickness.

The sleeve portion 52 is spaced from the induction coil 13 in the radial direction by a radial gap, having a width (radial extension) in a range between 0.5 millimeter and 1.5 millimeter, in particular between 0.8 millimeter and 1 millimeter. Advantageously, the radial gap may help to avoid heat losses from the induction coil to the sleeve portion, to reduce losses in the induction coil and to increase losses in the susceptor 22 to be heated, that is, to increase the heating efficiency of the aerosol-generating device 1. Likewise, each of the annular protrusion portions 51 is spaced from the induction coil 13 in the axial direction by an axial gap. The radial gap and/or the axial gap may be an air gap or a gap filled at least partially with a filler material.

Similar to the support tube 32 and the induction coil 13, the flux concentrator 50 may also have a non-circular flattened transverse cross-sectional shape corresponding to the non-circular flattened transverse cross-sectional shape of the support tube 32 and the induction 13. In particular, the transverse cross-sectional shape of the flux concentrator 50 may be obround.

As shown in FIG. 6, the more distal annular protrusion portions 51 comprise a recess or feedthrough opening 501 for passing through the connecting leads 60 for the induction coil. The recess or feedthrough opening 501 can be cut into the annular protrusion portion 51 after winding the flux concentrator foil.

In order to further increase the heating efficiency, the outer circumference of the support tube 32 of the present embodiment comprises a helical wire recess pattern 39—as shown in FIG. 4 and FIG. 6—which the coil wire is received in. Advantageously, the wire recess pattern 39 allows to further reduce the radial distance between the induction coil 13 and the susceptor location within the interior space of the induction coil 13. As already described above, a reduced radial distance leads an increase of the magnetic field strength at the location of the susceptor which in turn causes an increase of the heating efficiency.

The larger the depth of the recesses of the wire recess pattern 39, the better the magnetic field strength at the susceptor location within the interior space of the induction coil 13. For example, where the coil wire has a circular cross-section, a depth of the recesses of the wire recess pattern 39 in the radial direction preferably is in a range between 0.2 and 0.8, in particular 0.3 and 0.5, times a diameter of the coil wire. A distance in the radial direction between the induction coil 13 and an inner circumference of the coil support 17 may be in a range between 0.1 millimeter and 1 millimeter, in particular between 0.2 millimeter and 0.5 millimeter, preferably about 0.3 millimeter, as indicated in FIG. 6. This ensures a particular short radial distance between the induction coil 13 and the interior space of the support tube 32, where the susceptor 22 is to be received. That is, a in the radial direction between an inner circumference of the support tube 32 and a bottom of the recess pattern 39 is in a range between 0.1 millimeter and 1 millimeter, in particular between 0.2 millimeter and 0.5 millimeter, preferably about 0.3 millimeter.

A shown in FIG. 2 and FIG. 6, the outer circumference of the support tube 32 may further comprise a flux concentrator recess 38 for each of the annular protrusion portions 51 of the flux concentrator 50, in which a radially inward end of the respective annular protrusion portion 51 is received. Due to this, the annular protrusion portions 51 are safely supported which helps to prevent the flux concentrator 50 from being displaced. Otherwise, a displacement could lead to an undesired change in the inductance of the induction coil 13 and an undesired change of the magnetic field density in the interior space of the induction coil 13.

FIG. 7 shows further details of the inductive heating arrangement 10, in particular the power supply electronics that can be used in the aerosol-generating device shown in FIGS. 1-3. According to the present embodiment, the inductive heating arrangement 10 comprises a DC/AC inverter which is connect to the DC power supply 12 shown in FIG. 1. The DC/AC inverter includes a Class-E power amplifier which in turn includes the following components: a transistor switch 111 comprising a Field Effect Transistor T (FET), for example a Metal-Oxide-Semiconductor Field Effect Transistor (MOSFET), a transistor switch supply circuit indicated by the arrow 112 for supplying the switching signal (gate-source voltage) to the transistor switch 111, and an LC load network 113 comprising a shunt capacitor C1 and a series connection of a capacitor C2 and inductor L2. The inductor L2 corresponds to the induction coil 13 shown in FIG. 1-3 that is used to generate an alternating magnetic field within the cavity 16. In addition, there is provided a choke L1 for supplying a DC supply voltage +V_DC from the DC power supply 12. Also shown in FIG. 7 is the ohmic resistance R representing the total equivalent resistance or total resistive load 114, which-in use of the system, that is, when the article 2 is inserted in the cavity 16 of the device 1—is the sum of the ohmic resistance of the induction coil 13, marked as L2, and the ohmic resistance of the susceptor 22. Otherwise, in case no article is inserted in the cavity 16, the equivalent resistance or resistive load 114 only corresponds to the ohmic resistance of the induction coil 13.

FIG. 8 shows another embodiment of the power supply electronics that can be alternatively used in the aerosol-generating device shown in FIGS. 1-3 in order to provide a high frequency oscillating current to the induction coil 13. The configuration shown in FIG. 8 corresponds to the configuration of a class-D amplifier. There, the DC power supply 12 is connected to two transistors 1210, 1212. Two switching elements 1220, 1222 are provided for switching the two transistors 1210, 1212 on and off. The switching elements 1220, 1222 are controlled at high frequency in a manner so as to make sure that one of the two transistors 1210, 1212 has been switched off at the time the other of the two transistors is switched on. The induction coil 13 used to generated the alternating magnetic field for induction heating is again indicated by L2, whereas the combined ohmic resistance of the induction coil 13 and the susceptor 22 is indicated by R. The values of C1 and C2 can be chosen to maximize the efficient dissipation of power in the susceptor element. The capacitor C1 is not essential to configure the architecture as a class-D and thus can be omitted.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. -15. (canceled)

16. An induction heating module for an inductively heating aerosol-generating device, the induction heating module comprising:
a cylindrical-helical induction coil configured to generate an alternating magnetic field allowing to inductively heat a susceptor within an interior space of the cylindrical-helical induction coil in order to heat an aerosol-forming substrate in thermal contact or thermal proximity with the susceptor, wherein the cylindrical-helical induction coil is formed by one or more turns of a coil wire having a circular cross-section; and
a coil support configured to support the cylindrical-helical induction coil comprising a support tube, wherein the cylindrical-helical induction coil is wound around an outer circumference of the support tube, wherein the outer circumference of the support tube comprises a wire recess pattern the coil wire is received in, wherein the outer circumference of the support tube further comprises two flux concentration recesses suitable for receiving at least a respective annular protrusion portion of a flux concentrator, wherein the wire recess pattern is axially arranged between two flux concentration recesses, wherein the outer circumference of the support tube has a non-circular flattened transverse cross-sectional shape comprising two opposing flat sections connected by two opposing at least partially curved sections, and wherein the cylindrical-helical induction coil is wound around the outer circumference of the support tube such that a transverse cross-sectional shape of the cylindrical-helical induction coil follows the non-circular flattened transverse cross-sectional shape of the outer circumference of the support tube.

17. The induction heating module according to claim 16, wherein a distance between adjacent recesses of the wire recess pattern is larger than a diameter of the coil wire.

18. The induction heating module according to claim 16, wherein a distance between adjacent recesses of the wire recess pattern is in a range between 1.1 and 1.4 times a diameter of the coil wire.

19. The induction heating module according to claim 16, wherein the cylindrical-helical induction coil comprises 3 to 6 turns.

20. The induction heating module according to claim 16, wherein the coil wire has a diameter in the range between 0.8 millimeter and 1.5 millimeter.

21. The induction heating module according to claim 16, wherein the coil wire has a diameter in the range between 1 millimeter and 1.2 millimeter.

22. The induction heating module according to claim 16, wherein the wire recess pattern corresponds to a winding pattern of the cylindrical-helical induction coil.

23. The induction heating module according to claim 16, wherein the coil wire is one of a solid wire, a stranded wire, and a Litz wire.

24. The induction heating module according to claim 16,
wherein a depth of the recesses of the wire recess pattern in a radial direction is in a range between 0.2 and 0.8 times a diameter of the coil wire, and/or
wherein a distance in the radial direction between an inner circumference of the support tube and a bottom of the recess pattern is in a range between 0.1 millimeter and 1 millimeter, and/or
wherein a distance in the radial direction between an inner circumference of the cylindrical-helical induction coil and an inner circumference of the support tube is in a range between 0.1 millimeter and 1 millimeter.

25. The induction heating module according to claim 16,
wherein a depth of the recesses of the wire recess pattern in a radial direction is in a range between 0.3 and 0.5 times a diameter of the coil wire, and/or
wherein a distance in the radial direction between an inner circumference of the support tube and a bottom of the recess pattern is in a range between 0.2 millimeter and 0.5 millimeter, and/or
wherein a distance in the radial direction between an inner circumference of the cylindrical-helical induction coil and an inner circumference of the support tube is in a range between 0.2 millimeter and 0.5 millimeter.

26. The induction heating module according to claim 16, wherein the coil support comprises a circumferential collar at each axial end of the support tube.

27. The induction heating module according to claim 26, wherein the collar comprises a recess or feedthrough opening configured for passing through connecting leads for the cylindrical-helical induction coil.

28. The induction heating module according to claim 16, wherein the cylindrical-helical induction coil is wound around the outer circumference of the support tube such that a transverse cross-sectional shape of the cylindrical-helical induction coil follows the non-circular flattened transverse cross-sectional shape of the outer circumference of the support tube.

29. The induction heating module according to claim 28, wherein the non-circular flattened transverse cross-sectional shape of the support tube is obround.

30. The induction heating module according to claim 28, wherein the transverse cross-sectional shape of the cylindrical-helical induction coil is obround.

31. The induction heating module according to claim 28, wherein each of the at least partially curved sections is one of substantially semi-circular, substantially semi-oval, substantially semi-elliptical, or substantially parabolic.

32. An inductively heating aerosol-generating device for an aerosol-generating article, the aerosol-generating article comprising an aerosol-forming substrate configured to be heated by interaction of a susceptor with an alternating magnetic field provided by the aerosol-generating device, wherein the aerosol-generating device comprises an induction heating module according to claim 16.

33. An aerosol-generating system comprising an aerosol-generating device according to claim 32 and an aerosol-generating article for the aerosol-generating device, the aerosol-generating article comprising an aerosol-forming substrate configured to be heated by interaction of a susceptor with an alternating magnetic field provided by the aerosol-generating device.
